(19) United States
(12) Patent Application Publication
(10) Pub. No.: US 2015/0114532 A1
(43) Pub. Date: Apr. 30, 2015

(54) CAR COVER STRUCTURE

(71) Applicant: FORMOSA SAINT JOSE CORP., Taipei (TW)

(72) Inventor: Ming-Shun YANG, Taipei (TW)

(73) Assignee: FORMOSA SAINT JOSE CORP., Taipei (TW)

(21) Appl. No.: 14/095,710

(22) Filed: Dec. 3, 2013

(30) Foreign Application Priority Data
Oct. 28, 2013 (TW) 102138928

(51) Int. Cl. B60J 11/04

(52) U.S. Cl. CPC B60J 11/04
USPC 150/166

(57) ABSTRACT

The present invention discloses a car cover structure. One embodiment of the car cover structure includes a cover sheet, a transparent front unit and at least one entrance unit. Another embodiment of the car cover structure includes a cover sheet and a transparent front unit. Still another embodiment of the car cover structure includes a cover sheet and at least one entrance unit. With the implementation of the present invention, car cover structures can be manufactured cheep and easily cover and protect the whole car body from outside debris or dust without having any risk of scratching the car body. And at the same time, personnel can open a car door, enter or exit the car and see through to the outside from inside the car.

### BACKGROUND OF THE INVENTION

1. Technical Field

The present invention relates to car cover structures, and more particularly, to a car cover structure with a fender-aligned band unit or U-shaped coupling unit.

2. Description of Related Art

As cars are in increasingly wide use nowadays, consumers' demand for the completeness and beauty of new cars is ever-increasing. Automobile manufacturers always provide a certain degree of protection for new cars being delivered with a view to ensuring that the new cars will remain appealing and unscathed when delivered to consumers.

Cost-conscious automobile manufacturers cannot afford to allocate too much budget to protection of new cars, except for pricey high-class car models. As a result, conventional car covers for use with new cars ready for delivery have long been reduced to formality rather than been effective in enclosing the car body completely.

The fender-aligned portions of the conventional car cover are made from a rigid plastic plate so as to be fixed in place, resulting in disadvantages described below. The conventional car covers incur high manufacturing costs, fail to enclose the fenders fully, and scratch the baking varnish of the car body when used carelessly. In short, the conventional car covers are not only cost-ineffective but also fail to assure consumers that the car body will remain unscathed.

Accordingly, it is imperative to provide a car cover structure which is effective in covering and protecting the car body in its entirety completely, incurs low costs, features ease of use, solves usage-related problems with the prior art, and thus meets automakers' expectations in terms of low costs and high efficiency.

### SUMMARY OF THE INVENTION

The present invention discloses a car cover structure. One embodiment of the car cover structure includes a cover sheet, a transparent front unit and at least one entrance unit. Another embodiment of the car cover structure includes a cover sheet and a transparent front unit. Still another embodiment of the car cover structure includes a cover sheet and at least one entrance unit. With the implementation of the present invention, car cover structures can be manufactured cheep and easily cover and protect the whole car body from outside debris or dust without having any risk of scratching the car body. And at the same time, personnel can open a car door, enter or exit the car and see through to the outside from inside the car.

The present invention discloses a car cover structure, comprising: an enclosing body for covering a car body, wherein portions of the enclosing body correspond in position to fenders of the car body, respectively, and at least a band unit is disposed at the fender-aligned portions of the enclosing body; a front view unit provided in form of a transparent casing, embedded in the enclosing body, and positioned proximate to a windshield of the car body; and at least an entrance/exit unit formed by extending the enclosing body, positioned proximate to a front car door of the car body, and opened or shut by a U-shaped coupling unit.

The present invention also discloses a car cover structure, comprising: an enclosing body for covering a car body, wherein portions of the enclosing body correspond in position to fenders of the car body, respectively, and at least a band unit is disposed at the fender-aligned portions of the enclosing body; and a front view unit provided in form of a transparent casing, embedded in the enclosing body, and positioned proximate to a windshield of the car body.

The present invention further discloses a car cover structure, comprising: an enclosing body for covering a car body; a front view unit provided in form of a transparent casing, embedded in the enclosing body, and positioned proximate to a windshield of the car body; and at least an entrance/exit unit formed by extending the enclosing body, positioned proximate to a front car door of the car body, and opened or shut by a U-shaped coupling unit.

The present invention further discloses a car cover structure, comprising: an enclosing body for covering a car body; and at least an entrance/exit unit formed by extending the enclosing body, positioned proximate to a front car door of the car body, and opened or shut by a U-shaped coupling unit.

Implementation of the present invention at least involves the following inventive steps:

1. a car cover structure which not only incurs low manufacturing costs but is also quick and easy to install;

2. a car cover structure which covers a car and ensures that the car body, including all its fenders, will be fully protected;

3. a car cover structure which does not scratch the car body or the baking varnish thereof; and

4. a car cover structure allows users to open the car door at will in order to enter or exit the car, does not block the view from the car, and allows the users to move the car conveniently and safely.

The features and advantages of the present invention are detailed hereinafter with reference to the preferred embodiments. The detailed description is intended to enable a person skilled in the art to gain insight into the technical contents disclosed herein and implement the present invention accordingly. In particular, a person skilled in the art can easily understand the objects and advantages of the present invention by referring to the disclosure of the specification, the claims, and the accompanying drawings.

### BRIEF DESCRIPTION OF THE SEVERAL VIEWS OF THE DRAWINGS

The invention as well as a preferred mode of use, further objectives and advantages thereof will be best understood by reference to the following detailed description of illustrative embodiments when read in conjunction with the accompanying drawings, wherein:

FIG. 1 is a schematic perspective view of a car cover structure according to an embodiment of the present invention;

FIG. 2 is a schematic perspective view of another car cover structure according to an embodiment of the present invention;

FIG. 3 is a schematic perspective view of yet another car cover structure according to an embodiment of the present invention;

FIG. 4 is a schematic perspective view of a further car cover structure according to an embodiment of the present invention;

FIG. 5A is a schematic perspective view of a car cover structure with a plait unit according to an embodiment of the present invention;

FIG. 5B is a schematic perspective view of another car cover structure with a plait unit according to an embodiment of the present invention;

FIG. 6A is a schematic perspective view of a car cover structure with a transparent mask according to an embodiment of the present invention;

FIG. 6B is a schematic perspective view of another car cover structure with a transparent mask according to an embodiment of the present invention;

FIG. 6C is a schematic perspective view of yet another car cover structure with a transparent mask according to an embodiment of the present invention;

FIG. 7A is a schematic perspective view of a car cover structure with a rear-view mirror casing according to an embodiment of the present invention;

FIG. 7B is a schematic perspective view of another car cover structure with a rear-view mirror casing according to an embodiment of the present invention;

FIG. 7C is a schematic perspective view of yet another car cover structure with a rear-view mirror casing according to an embodiment of the present invention;

FIG. 7D is a schematic perspective view of a further car cover structure with a rear-view mirror casing according to an embodiment of the present invention;

FIG. 7E is a front view of a car cover structure with a rear-view mirror casing according to an embodiment of the present invention;

FIG. 8A is a schematic view of a U-shaped coupling unit according to an embodiment of the present invention; and

FIG. 8B is a schematic view of another U-shaped coupling unit.

### DETAILED DESCRIPTION OF THE EMBODIMENTS OF THE INVENTION

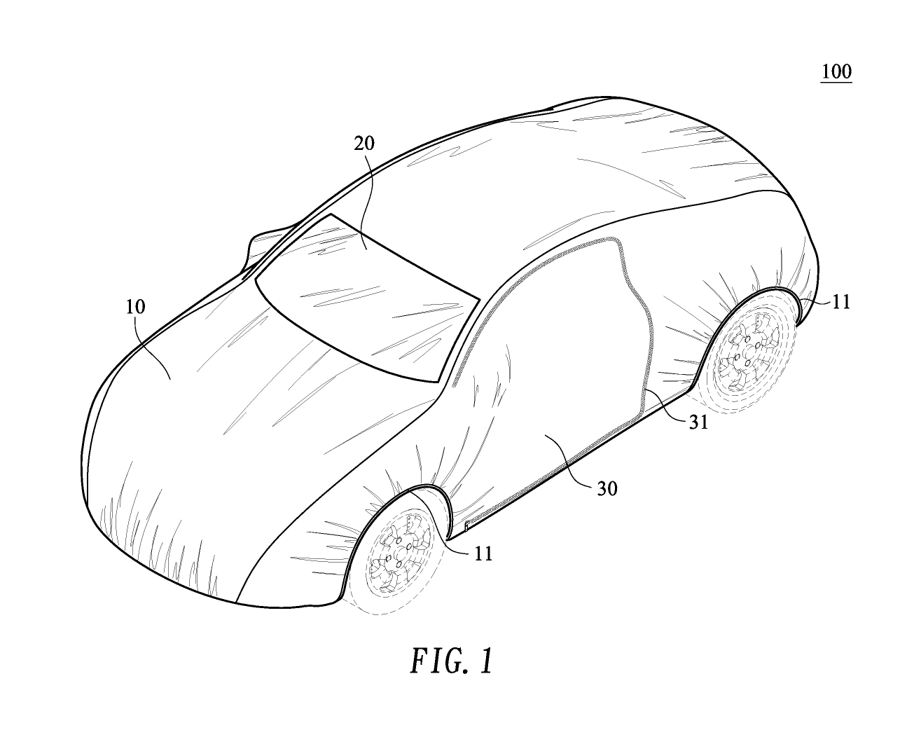

Referring to FIG. 1, in an embodiment of the present invention, a car cover structure 100 comprises an enclosing body 10, a front view unit 20, and at least an entrance/exit unit 30.

Referring to FIG. 1, the enclosing body 10 is made of a material which is lightweight, incurs a low cost, and does not scratch a car body of a car. The enclosing body 10 serves to cover the car body of the car. When the car body of the car is covered with the enclosing body 10, portions of the enclosing body 10 correspond in position to fenders of the car body, respectively. At least a band unit 11 is disposed at the fender-aligned portions of the enclosing body 10. Thanks to the at least a band unit 11, the enclosing body 10 covers each of the fenders of the car body fully and is fixed to each of the fenders so as to enclose the car body tightly; hence, the enclosing body 10 is unlikely to bulge even when exposed to strong winds or pulled under an external force.

Referring to FIG. 1 the at least a band unit 11 is provided in the form of an elastic cord, an elastic ribbon, a plait, or a cord. The at least a band unit 11 enables the fender-aligned portions of the enclosing body 10 to enclose the fenders of the car body tightly, respectively. Furthermore, the at least a band unit 11 is made of a material tough but soft enough to avoid scratching the car body or the baking varnish thereof.

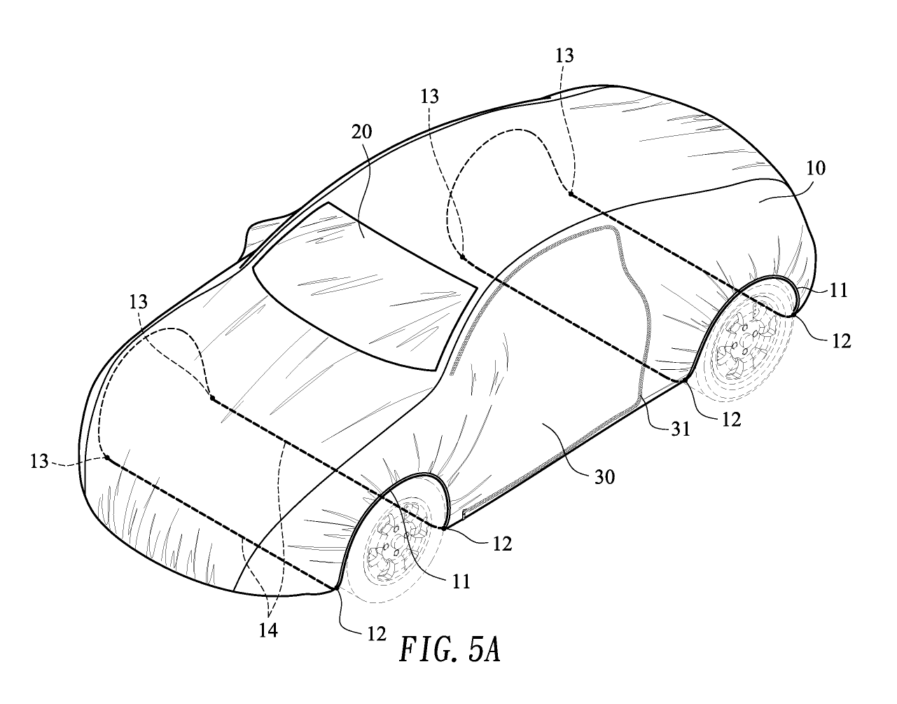

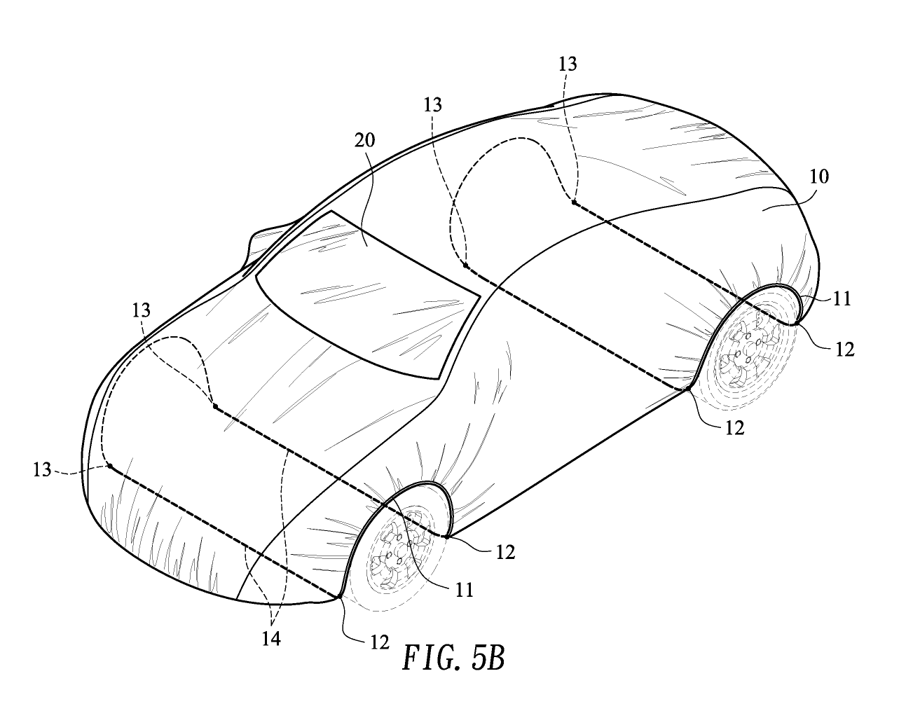

Referring to FIG. 5A, a plait unit 14 is fixed to the enclosing body 10 and corresponds in position to a first fender end 12 at each of the fenders on one side of the car body. The plait unit 14 extends to the other side of the car body so as to be fixed to the enclosing body 10 and correspond in position to a second fender end 13 opposite to the first fender end 12.

Referring to FIG. 5A, the two front fenders of the car body together has two plait units 14, so is the two rear fenders of the car body. The plait units 14 extend from one side of the car body to the other side of the car body and are fixed in place by means of knotting, clamping, or the like, such that the car cover structure 100 covers the car body tightly and is unlikely to bulge even when pulled under an external force.

Referring to FIG. 1, the front view unit 20 is provided in the form of a transparent casing, embedded in the enclosing body 10, and positioned proximate to a windshield of the car body. The front view unit 20 provided in the form of the transparent casing enables users inside the car to have a view of the outside from the car by looking through the windshield and the front view unit 20 of the enclosing body 10, thereby facilitating movement of the car.

Referring to FIG. 1, the entrance/exit unit 30 is formed by extending the enclosing body 10 and corresponds in position to the front car door of the car body. The entrance/exit unit 30 has a U-shaped coupling unit 31 whereby the entrance/exit unit 30 is opened or shut. To enter or exit the car, a user splits the U-shaped coupling unit 31 and opens the car door.

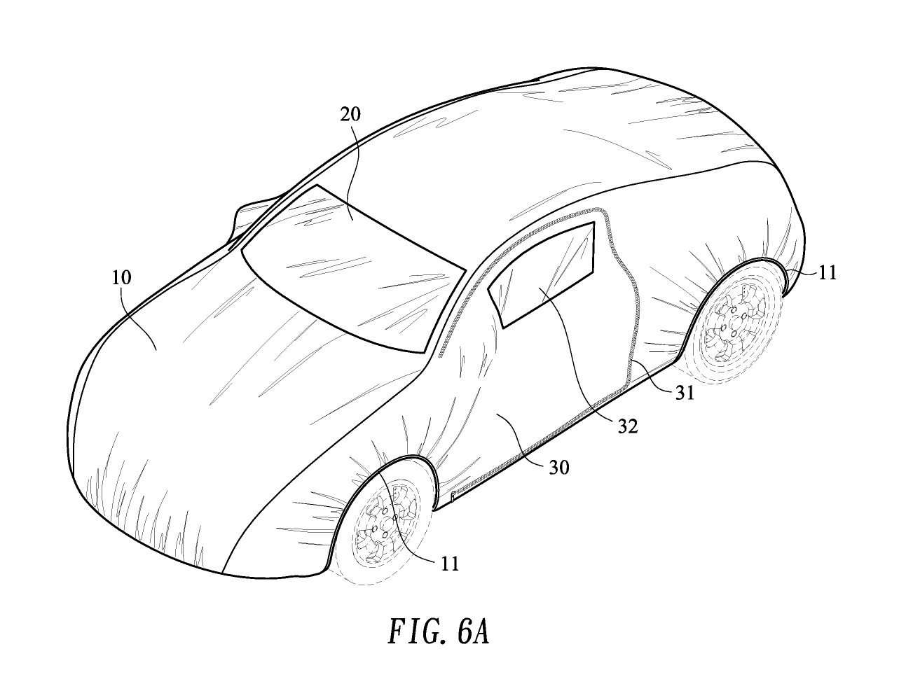

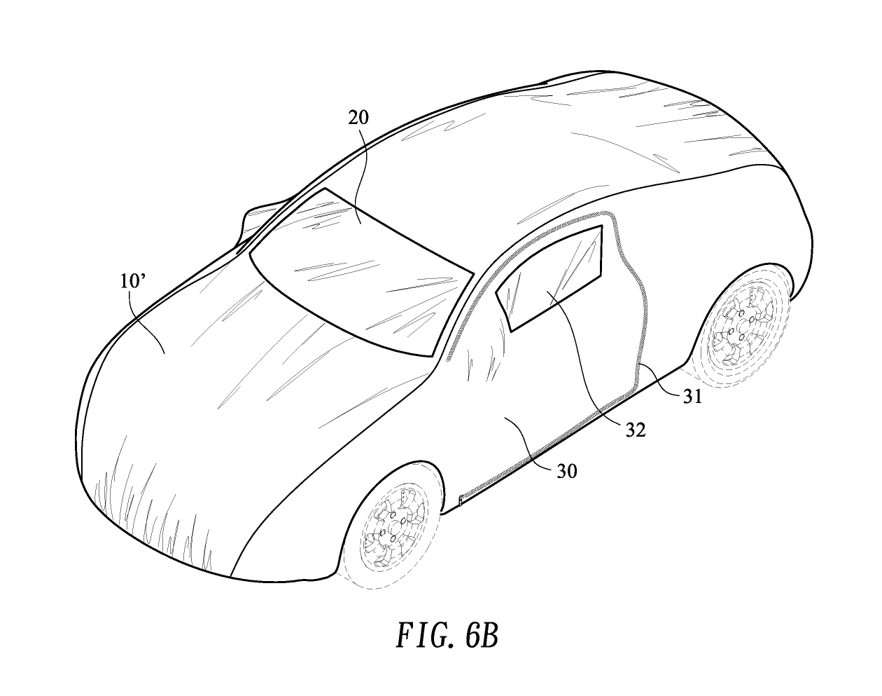

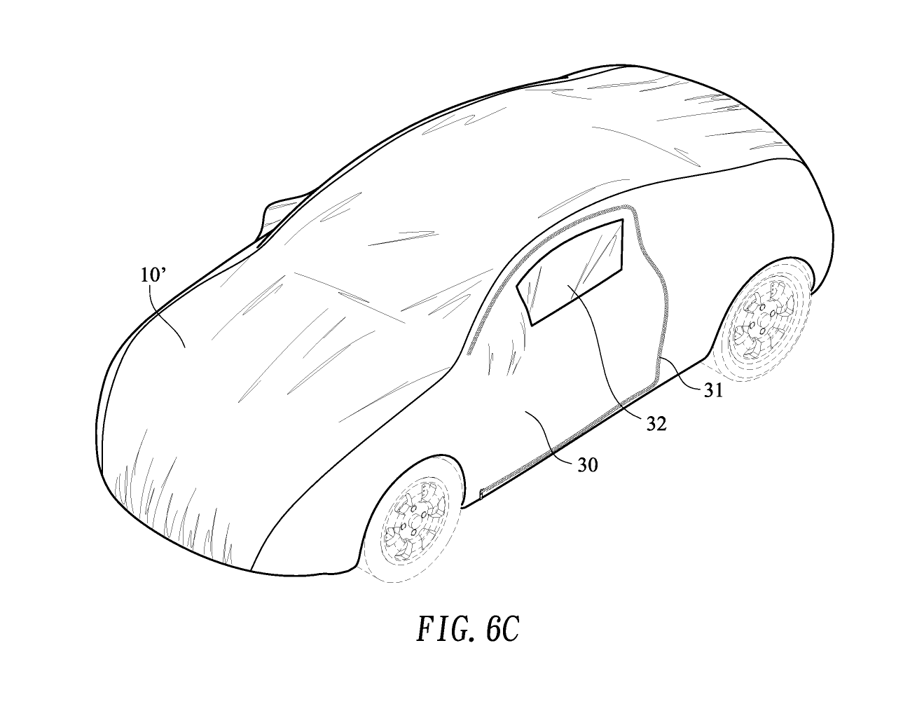

Referring to FIG. 6A, a transparent mask 32 is embedded in the entrance/exit unit 30 and positioned proximate to a window of the front car door. Users in the car have a view of the outside from the car by looking through the window and the transparent mask 32, thereby allowing the car to move safely.

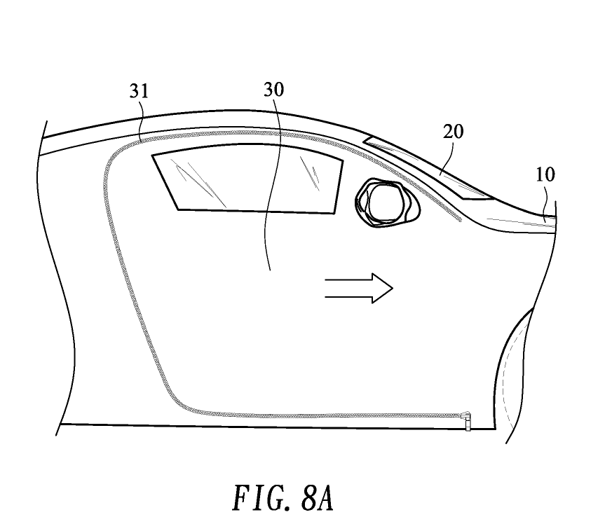

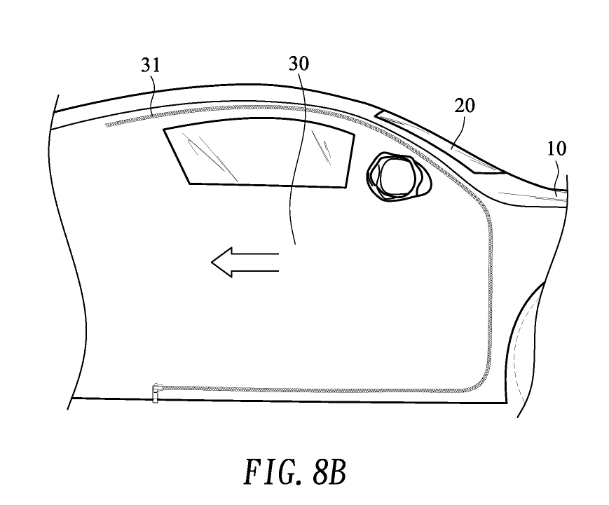

Referring to FIG. 8A and FIG. 8B, the U-shaped coupling unit 31 of the entrance/exit unit 30 is oriented in such a manner as to allow the U-shape of the U-shaped coupling unit 31 to open in the direction of the head or tail of the car body.

The U-shaped coupling unit 31 is provided in the form of a U-shaped zipper or a hook-and-loop fastener, which is capable of coupling and decoupling.

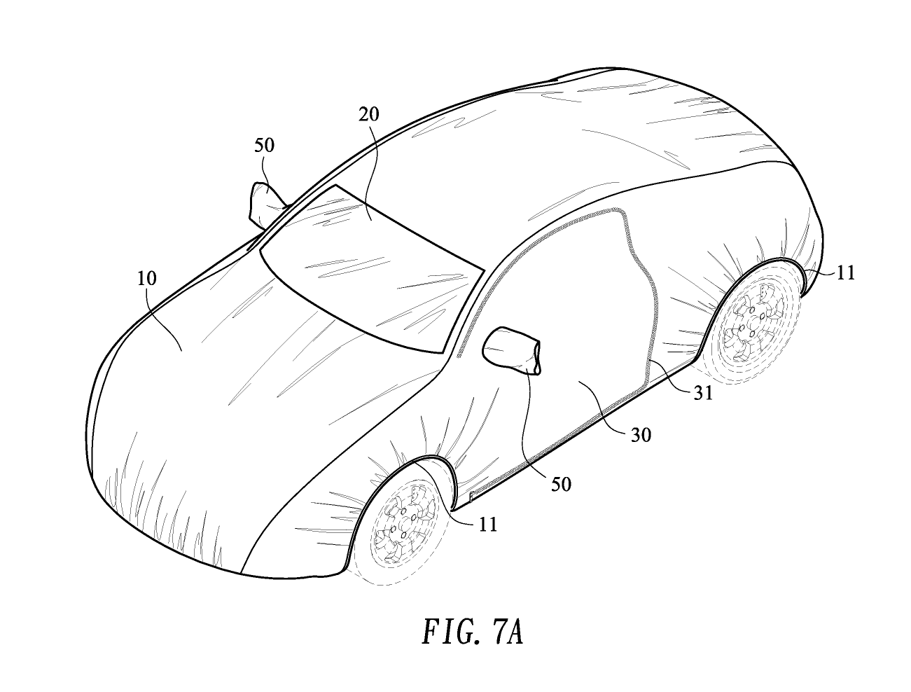

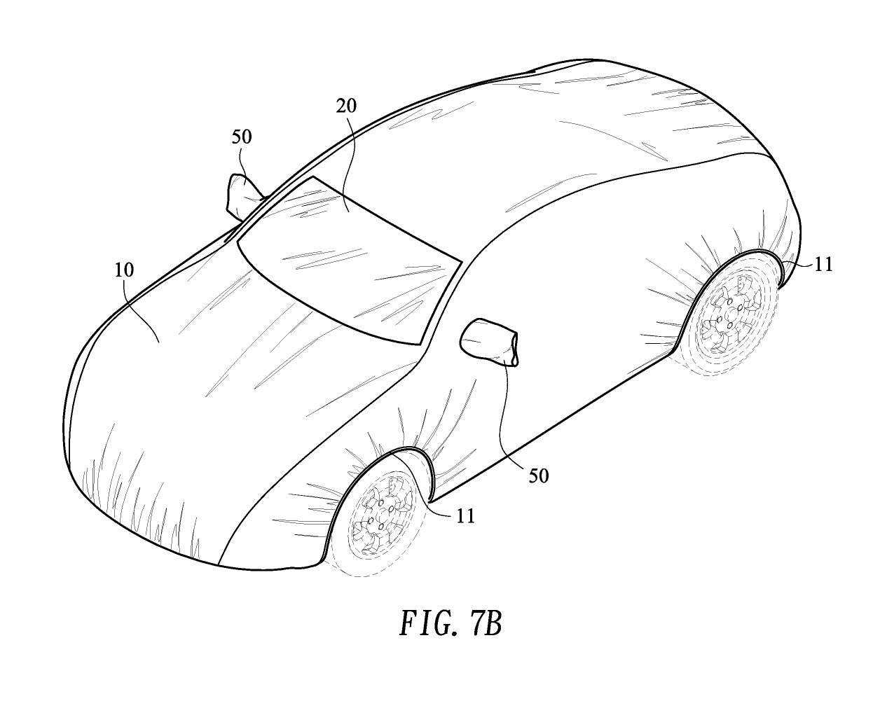

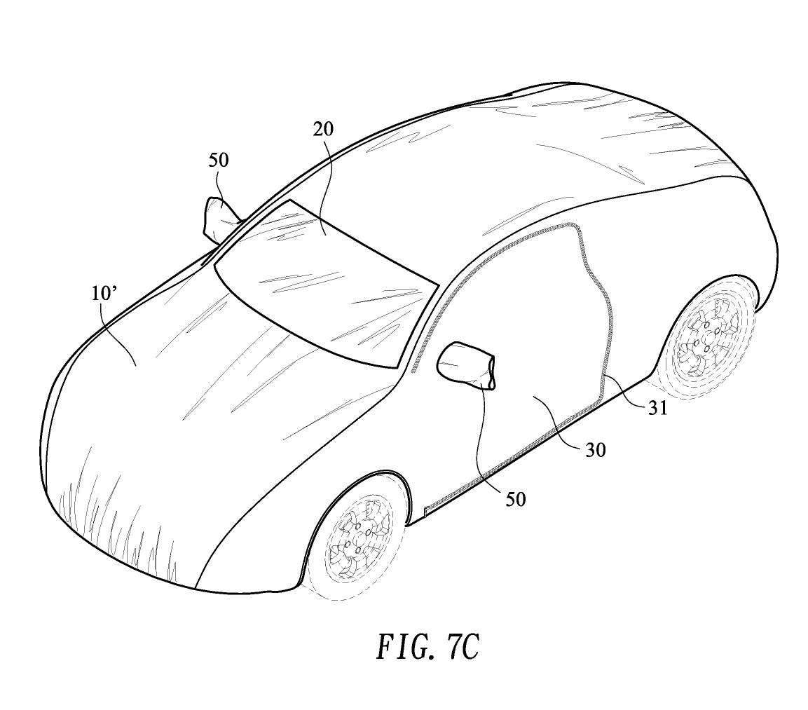

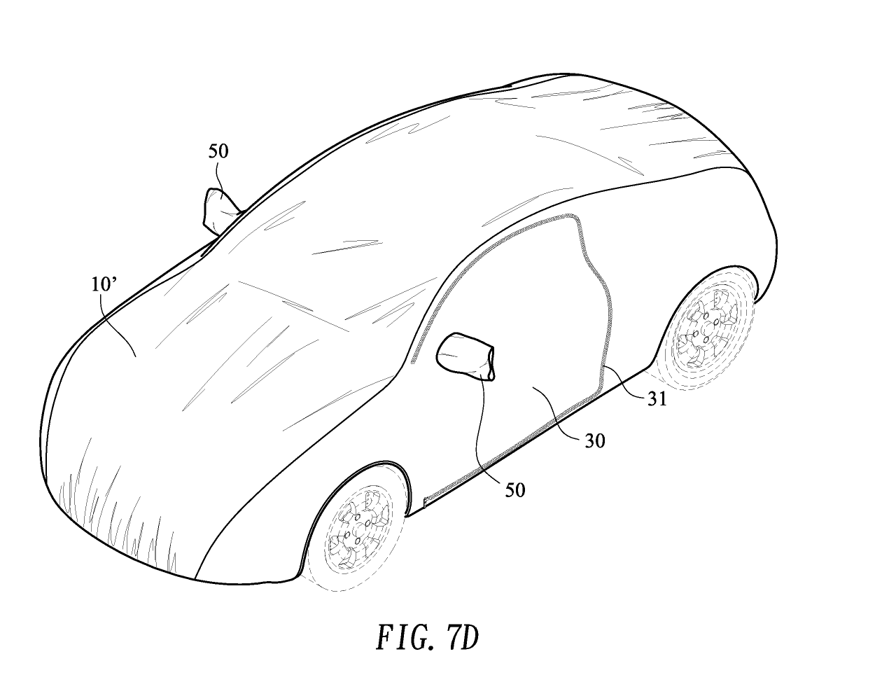

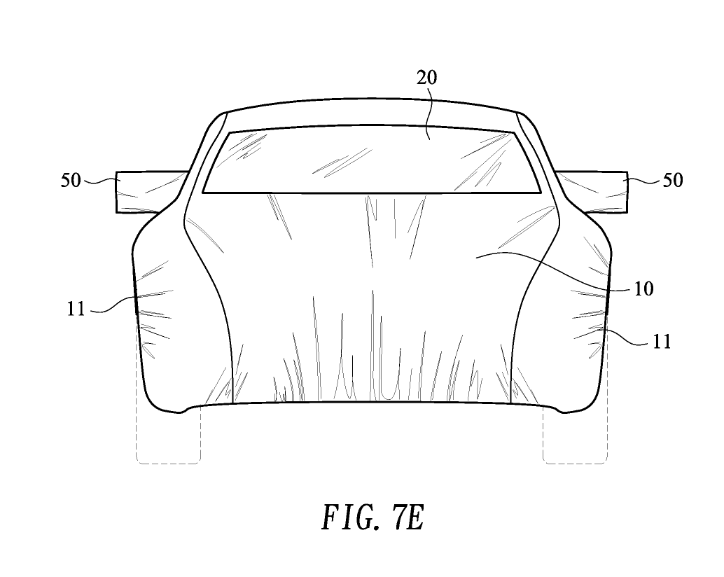

Referring to FIG. 7A and FIG. 7E, the enclosing body 10 further comprises at least a rear-view mirror casing 50. The rear-view mirror casing 50 is provided in the form of a hollow-core casing and formed by extending the enclosing body 10. The rear-view mirror casing 50 corresponds in position to a rear-view mirror of the car. When unfolded, the rear-view mirror is concealed and protected by the rear-view mirror casing 50.

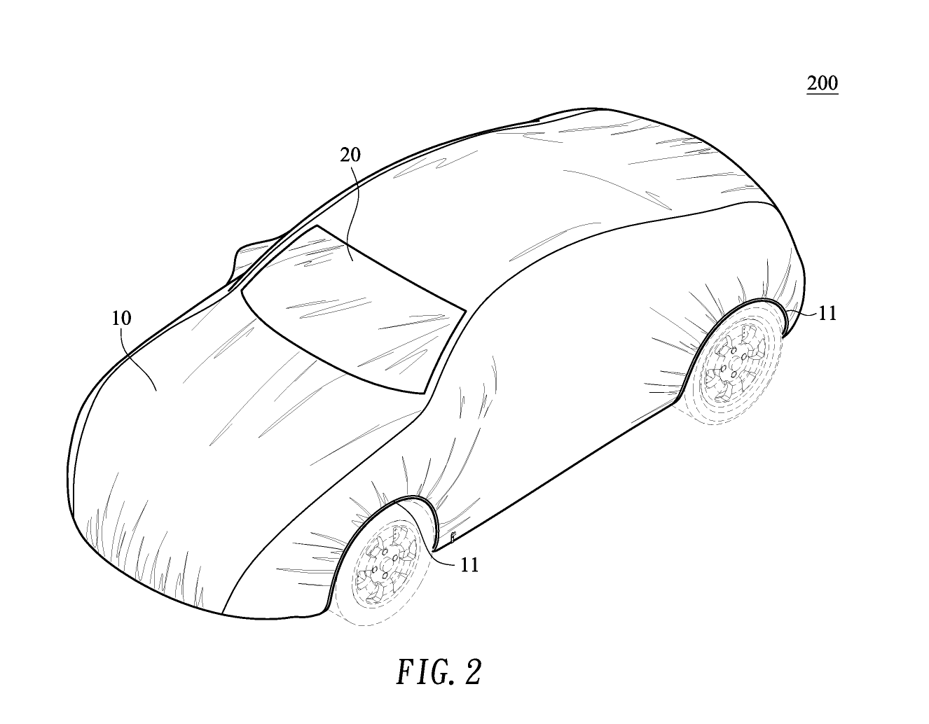

Referring to FIG. 2, in an embodiment of the present invention, a car cover structure 200 comprises an enclosing body 10 and a front view unit 20.

Referring to FIG. 2, features and connections of the enclosing body 10 and the front view unit 20 of the car cover structure 200 are identical to those of the enclosing body 10 and the front view unit 20 of the car cover structure 100, respectively, and thus are not described in detail herein for the sake of brevity.

Referring to FIG. 5B, a plait unit 14 is fixed to the enclosing body 10 of the car cover structure 200. Referring to FIG. 7B, at least a rear-view mirror casing 50 is disposed at the enclosing body 10 of the car cover structure 200.

Features and connections of the plait unit 14 shown in FIG. 5B and the rear-view mirror casing 50 shown in FIG. 7B are identical to those of the plait unit 14 and the rear-view mirror casing 50 of the car cover structure 100, respectively, and thus are not described in detail herein for the sake of brevity.

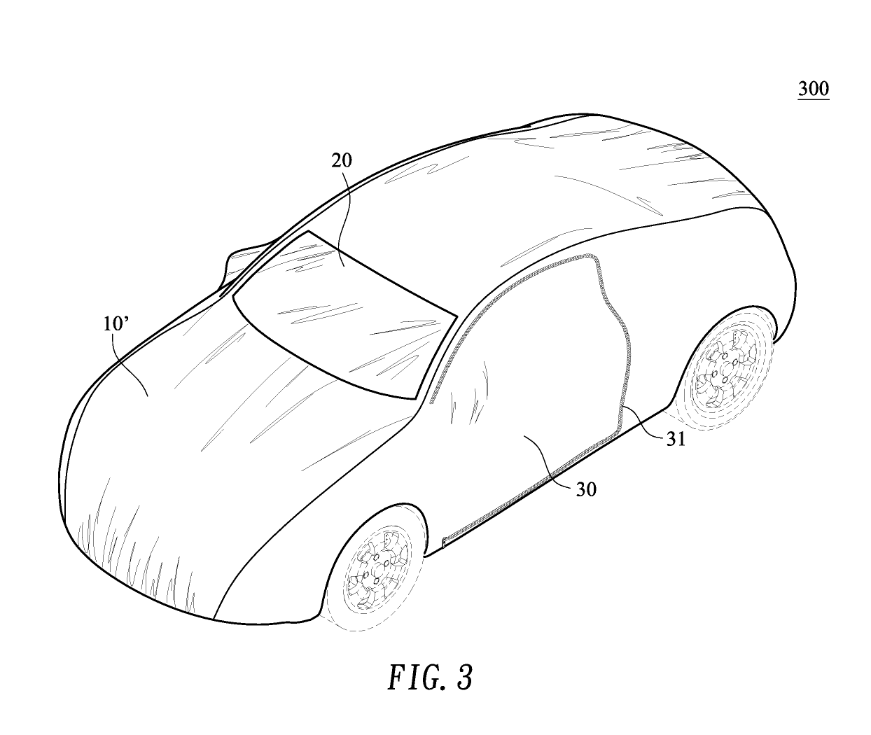

Referring to FIG. 3, in an embodiment of the present invention, a car cover structure 300 comprises an enclosing body 10′, a front view unit 20 and at least an entrance/exit unit 30. The enclosing body 10′ of the car cover structure 300 covers the car body and is made of a material which is lightweight, incurs low costs, does not scratch the car body, and thus serves protective and dust-free purposes.

Features and connections of the front view unit 20 and the entrance/exit unit 30 of the car cover structure 300 shown in FIG. 3 are identical to those of the front view unit 20 and the entrance/exit unit 30 of the car cover structure 100, respectively, and thus are not described in detail herein for the sake of brevity.

Referring to FIG. 6B, a transparent mask 32 is embedded in the entrance/exit unit 30 of the car cover structure 300 and positioned proximate to a window of the front car door. Referring to FIG. 7C, at least a rear-view mirror casing 50 is disposed at the enclosing body 10′ of the car cover structure 300.

Features and connections of the transparent mask 32 of the car cover structure 300 shown in FIG. 6B and the rear-view mirror casing 50 of the car cover structure 300 shown in FIG. 7C are identical to those of the transparent mask 32 and the rear-view mirror casing 50 of the car cover structure 100, respectively, and thus are not described in detail herein for the sake of brevity.

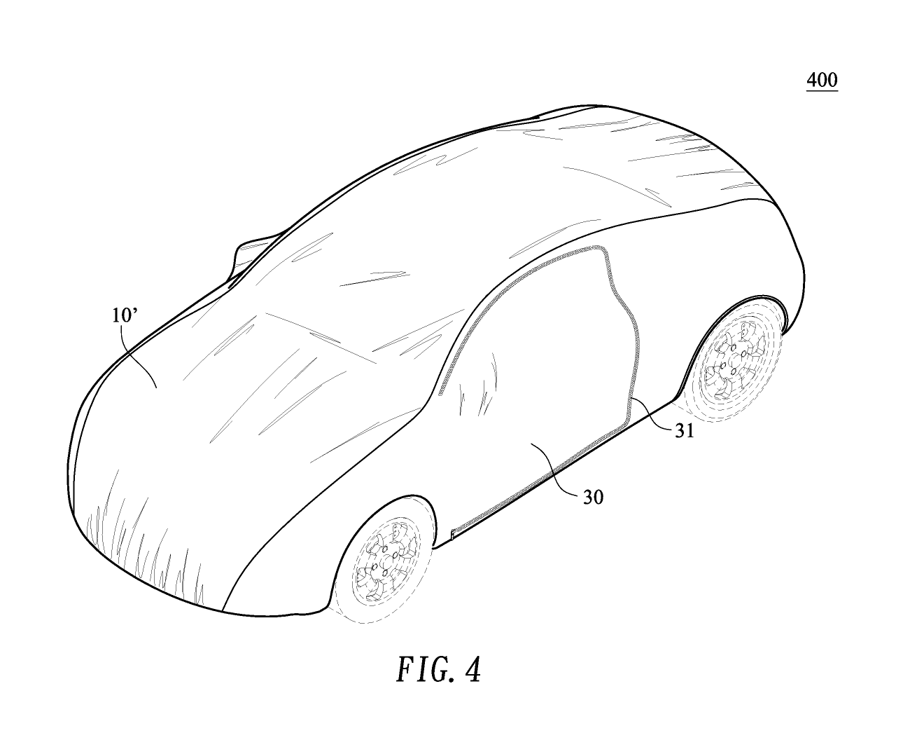

Referring to FIG. 4, in an embodiment of the present invention, a car cover structure 400 comprises an enclosing body 10′ and at least an entrance/exit unit 30. The enclosing body 10′ serves to cover the car body and is made of a material which is lightweight, incurs low costs, does not scratch the car body, and thus serves protective and dust-free purposes. Features and connections of the entrance/exit unit 30 are identical to those of the entrance/exit unit 30 of the car cover structure 100.

Referring to FIG. 6C, a transparent mask 32 is embedded in the entrance/exit unit 30 of the car cover structure 400 and positioned proximate to a window of the front car door. Referring to FIG. 7D, at least a rear-view mirror casing 50 is disposed at the enclosing body 10′ of the car cover structure 400.

Features and connections of the transparent mask 32 shown in FIG. 6C and the rear-view mirror casing 50 shown in FIG. 7D are identical to those of the transparent mask 32 and the rear-view mirror casing 50 of the car cover structure 100, respectively, and thus are not described in detail herein for the sake of brevity.

In conclusion, as indicated by the description of the aforesaid embodiments, the car cover structure 100, the car cover structure 200, the car cover structure 300, and the car cover structure 400, which are made of a material lightweight and unlikely to scratch the car body, incur low manufacturing costs, feature ease of use, and are effective in covering and protecting the car body.

The embodiments described above are intended only to demonstrate the technical concept and features of the present invention so as to enable a person skilled in the art to understand and implement the contents disclosed herein. It is understood that the disclosed embodiments are not to limit the scope of the present invention. Therefore, all equivalent changes or modifications based on the concept of the present invention should be encompassed by the appended claims.

What is claimed is:

1. A car cover structure, comprising:
an enclosing body for covering a car body, wherein portions of the enclosing body correspond in position to fenders of the car body, respectively, and at least a band unit is disposed at the fender-aligned portions of the enclosing body;
a front view unit provided in form of a transparent casing, embedded in the enclosing body, and positioned proximate to a windshield of the car body; and
at least an entrance/exit unit formed by extending the enclosing body, positioned proximate to a front car door of the car body, and opened or shut by a U-shaped coupling unit.

2. A car cover structure, comprising:
an enclosing body for covering a car body, wherein portions of the enclosing body correspond in position to fenders of the car body, respectively, and at least a band unit is disposed at the fender-aligned portions of the enclosing body; and
a front view unit provided in form of a transparent casing, embedded in the enclosing body, and positioned proximate to a windshield of the car body.

3. A car cover structure, comprising:
an enclosing body for covering a car body;
a front view unit provided in form of a transparent casing, embedded in the enclosing body, and positioned proximate to a windshield of the car body; and
at least an entrance/exit unit formed by extending the enclosing body, positioned proximate to a front car door of the car body, and opened or shut by a U-shaped coupling unit.

4. A car cover structure, comprising:
an enclosing body for covering a car body; and
at least an entrance/exit unit formed by extending the enclosing body, positioned proximate to a front car door of the car body, and opened or shut by a U-shaped coupling unit.

5. The car cover structure of claim 1, wherein the band unit is provided in form of one of an elastic cord, an elastic ribbon, a plait, and a cord to enable fender-aligned portions of the enclosing body to enclose the fenders tightly, respectively.

6. The car cover structure of claim 2, wherein the band unit is provided in form of one of an elastic cord, an elastic ribbon, a plait, and a cord to enable fender-aligned portions of the enclosing body to enclose the fenders tightly, respectively.

7. The car cover structure of claim 1, wherein a plait unit is fixed to the enclosing body and corresponds in position to a first fender end at each of the fenders on one side of the car body.

8. The car cover structure of claim 2, wherein a plait unit is fixed to the enclosing body and corresponds in position to a first fender end at each of the fenders on one side of the car body.

9. The car cover structure of claim 7, wherein the plait unit extends to another side of the car body so as to be fixed to the enclosing body and correspond in position to a second fender end opposite to the first fender end.

10. The car cover structure of claim 8, wherein the plait unit extends to another side of the car body so as to be fixed to the enclosing body and correspond in position to a second fender end opposite to the first fender end.

11. The car cover structure of claim 1, wherein a transparent mask is embedded in the entrance/exit unit and corresponds in position to a window of the front car door.

12. The car cover structure of claim 3, wherein a transparent mask is embedded in the entrance/exit unit and corresponds in position to a window of the front car door.

13. The car cover structure of claim 4, wherein a transparent mask is embedded in the entrance/exit unit and corresponds in position to a window of the front car door.

14. The car cover structure of any one of claim 1, wherein the enclosing body further has at least a rear-view mirror casing provided in form of a hollow-core casing, formed by extending the enclosing body, and positioned proximate to a rear-view mirror of the car.

15. The car cover structure of any one of claim 2, wherein the enclosing body further has at least a rear-view mirror casing provided in form of a hollow-core casing, formed by extending the enclosing body, and positioned proximate to a rear-view mirror of the car.

16. The car cover structure of any one of claim 3, wherein the enclosing body further has at least a rear-view mirror casing provided in form of a hollow-core casing, formed by extending the enclosing body, and positioned proximate to a rear-view mirror of the car.

17. The car cover structure of any one of claim 4, wherein the enclosing body further has at least a rear-view mirror casing provided in form of a hollow-core casing, formed by extending the enclosing body, and positioned proximate to a rear-view mirror of the car.

18. The car cover structure of claim 1, wherein the U-shaped coupling unit is oriented in such a manner as to allow its U-shape to open in a direction of a head or tail of the car body.

19. The car cover structure of claim 3, wherein the U-shaped coupling unit is oriented in such a manner as to allow its U-shape to open in a direction of a head or tail of the car body.

20. The car cover structure of claim 4, wherein the U-shaped coupling unit is oriented in such a manner as to allow its U-shape to open in a direction of a head or tail of the car body.

21. The car cover structure of claim 1, wherein the U-shaped coupling unit is a U-shaped zipper.

22. The car cover structure of claim 3, wherein the U-shaped coupling unit is a U-shaped zipper.

23. The car cover structure of claim 4, wherein the U-shaped coupling unit is a U-shaped zipper.
